(19) United States
(12) Patent Application Publication
(10) Pub. No.: US 2017/0304926 A1
(43) Pub. Date: Oct. 26, 2017

(54) HOMOPOLOR GENERATOR PULSED WELDING GENERATOR SUBSYSTEMS

(71) Applicant: The Board of Regents of The University of Texas System, Austin, TX (US)

(72) Inventors: Raymond C. Zowarka, Austin, TX (US); Ben Rech, Austin, TX (US); Joe Koo, Austin, TX (US); Jon Hahne, Georgetown, TX (US); David N. Prater, Austin, TX (US); Charles E. Penney, Round Rock, TX (US); Bryan Bunkowski, Austin, TX (US); Siddharth Pratap, Orange, CA (US)

(21) Appl. No.: 15/496,606

(22) Filed: Apr. 25, 2017

Related U.S. Application Data
(60) Provisional application No. 62/327,754, filed on Apr. 26, 2016.

(51) Int. Cl. B23K 11/24; H02K 5/16; H02K 5/14; B23K 11/02; F16C 19/18; B23K 11/00; F16C 27/04; H02K 31/02; F16C 33/32; B23K 101/28

(52) U.S. Cl. CPC B23K 11/241; H02K 31/02; H02K 5/165; H02K 5/14; F16C 33/32; B23K 11/02; F16C 19/184; B23K 11/002; F16C 27/04; B23K 2201/28; F16C 2206/40; F16C 2380/26

(57) ABSTRACT

Described herein are methods and system for welding, for example, girders. The method may include activating a homopolar generator. The method may include applying a force to two metal girders at a desired coupling joint. The method may include generating an electrical pulse using the homopolar generator and conducting the electrical pulse to the desired coupling joint to increase a temperature of the girders. The method may include forming a weld at the desired coupling joint attaching the two metal girders at the desired coupling joint. In some embodiments, the homopolar generator may include a radial bearing rotor including a rotatable shaft and a bearing assembly. The bearing assembly may include nonmagnetic bearings. The homopolar generator may include a field coil. The homopolar generator may include a brush actuation mechanism which when activated engages a plurality of brush devices to the radial bearing rotor.

### PRIORITY CLAIM

This application claims priority to U.S. Provisional Application Ser. No. 62/327,754 entitled “HOMOPOLOR GENERATOR PULSED WELDING GENERATOR SUBSYSTEMS” filed Apr. 26, 2016, which is incorporated herein by reference in its entirety.

### STATEMENT REGARDING FEDERALLY SPONSORED RESEARCH OR DEVELOPMENT

This invention was made with government support under Grant no. DTRT57-15-C-10011 awarded by the U. S. Department of Transportation. The government has certain rights in the invention.

### BACKGROUND

### 1. Technical Field

The invention generally relates to systems and methods of joining two or more pieces of metal. More particularly, some embodiments disclosed herein relate to systems and methods for facilitating the welding of large steel beams or girders using a homopolar generator.

### 2. Description of the Relevant Art

A homopolar generator is a direct current (DC) electrical generator including an electrically conductive disc or cylinder rotating in a plane perpendicular to a uniform static magnetic field. A potential difference is created between the center of the disc and the rim or between the two ends of the drum with an electrical polarity that depends on the direction of rotation and the orientation of the field. For the disk sliding contacts on the shaft and rotor serve as current collection devices and for the drum contacts at each end of the rotor serve as current collectors. A “disk-type” or “drum-type” generator may be used in connection with the present invention. The homopolar generator stores the energy at low power over a longer time interval and then delivers very high power over a short time. The stored energy is proportional to the moment of inertia of the rotor and rotor speed squared.

Homopolar pulse welding utilizes a high current, low voltage pulse produced by a homopolar generator to rapidly resistance heat an interface between two components to forging temperature. In homopolar pulse welding methods typically flat ends of two workpieces are carefully aligned and held under a light initial load to focus heat generation at the interface. As the current pulse is discharged through the workpieces, the intense heat generated at this interface diffuses axially, softening the adjacent material. After a preset delay, an upset force is then applied to produce a forge weld at the interface. Only a few seconds are required from initiation of the pulse to completion of the weld. Homopolar pulse welding may be used to rapidly join lengths of pipe in pipeline construction (e.g., deep water offshore pipeline construction systems). Homopolar pulse welding may be used in joining rails in railroad construction or brazing, compaction, or forging.

By changing the rotor speed a family of welds is possible stepping from low cross section to high cross section as such one machine may be used to complete multiple projects. One machine therefore, provides the ability to weld a range of tubing or pipe sizes. Although homopolar generators have been known for decades their unique properties have not been utilized to their fullest in the field of, for example, welding due to the high production costs associated with the generators.

Therefore, a system and/or method which simplifies and/or reduces the production costs associated with producing a homopolar generator would be beneficial.

### SUMMARY

Embodiments described herein relate to systems and methods for joining two or more pieces of metal. More particularly, some embodiments disclosed herein relate to systems and methods for facilitating the welding of large steel beams or girders. The method may include activating a homopolar generator. The method may include applying a force to two metal girders at a desired coupling joint. The method may include generating an electrical pulse using the homopolar generator and conducting the electrical pulse to the desired coupling joint to increase a temperature of the girders adjacent the desired coupling joint. The method may include forming a weld at the desired coupling joint attaching the two metal girders at the desired coupling joint. In some embodiments, the homopolar generator may include a radial bearing rotor comprising a rotatable shaft and a bearing assembly positioned on the rotatable shaft. The bearing assembly may include nonmagnetic bearings. The homopolar generator may include a field coil, wherein the radial bearing rotates, during use, in the field coil with assistance of the bearing assembly. The homopolar generator may include a plurality of brush devices which when activated engage the rotating radial bearing rotor. The homopolar generator may include a brush actuation mechanism which when activated engages, during use, the plurality of brush devices to the radial bearing rotor.

In some embodiments, the nonmagnetic bearings comprise ceramic bearings.

In some embodiments, the homopolar generator may include a bearing housing positioned on the rotatable shaft such that the bearing assembly is inhibited from disengaging from the rotatable shaft. The bearing housing may be radially stiff and circumferentially compliant. The bearing housing may be formed from a substantially inflexible material and include a small break in an otherwise uninterrupted circular shape allowing contraction and/or expansion of the circular shape.

In some embodiments, the plurality of brush devices may include a brush holder comprising a brush pad, a plurality of straps, and a resilient member. The plurality of brush devices may be coupled to at least one actuator rod. The plurality of brush devices may be coupled to at least one actuator rod. The at least one actuator rod may be formed from an electrically insulated material. The brush actuation mechanism may include an actuation ring coupled to the at least one actuator rod such that when the actuation ring is rotated the plurality of brush devices engage the radial bearing rotor.

### BRIEF DESCRIPTION OF THE DRAWINGS

Advantages of the present invention will become apparent to those skilled in the art with the benefit of the following detailed description of embodiments and upon reference to the accompanying drawings.

FIG. 1 depicts an embodiment of a cross sectional view of a homopolar generator.

FIG. 2 depicts an embodiment of a cross sectional view of a bearing assembly of a homopolar generator.

FIG. 3 depicts an embodiment of a cross sectional view of a bearing assembly and a load member of a homopolar generator.

FIG. 4 depicts an embodiment of a perspective view of a load member of a homopolar generator.

FIG. 5 depicts an embodiment of a perspective view of a brush device of a homopolar generator during assembly of the brush device.

FIG. 6 depicts an embodiment of a perspective view of a brush device of a homopolar generator.

FIG. 7 depicts an embodiment of a perspective view of a brush assembly of a homopolar generator.

FIG. 8 depicts an embodiment of a perspective view of a brush actuation system of a homopolar generator.

FIG. 9 depicts an embodiment of a perspective view of a plurality of brush assemblies as assembled in a homopolar generator.

FIGS. 10A-B depict an embodiment of a perspective view and a front view respectively of a homopolar generator.

FIG. 11 depicts an embodiment of a typical brush arrangement for one row.

FIG. 12 depicts an embodiment of non-uniform flux linkages for the different brush paths due to leakage fields in the brush region such that a brush closest to the active length has the lowest resistance and the one furthest has the highest.

FIG. 13 depicts an embodiment of different flux linkages.

FIG. 14 depicts an embodiment of a detailed model in Matlab/Simulink to determine brush current distribution. The coupled circuit model accounts for the inductance and resistances. The shaded voltage sources represent the differential voltages.

FIG. 15 depicts an embodiment of a System Simulation with 4 HPGs (shaded blocks) that have the detailed model of FIG. 14 to study the current distribution under the actual pulse shape.

FIGS. 16A-B depict graphical representations of the results of the simulation of the current distribution for case 1. As case 1 is the ideal case the currents distribute fairly uniformly. The slight uneven distribution initially is due to the inductances being different for each path, in general the current distribution is fairly uniform.

FIGS. 17A-B depict graphical representations of the results of the simulation of the current distribution for case 2. The current distribution is fairly non-uniform. The current distribution is very non-uniform with some of the brushes not carrying any current and some carrying significantly higher than rated.

FIGS. 18A-B depict graphical representations of the results of the simulation of the current distribution for case 2. Due to the offsetting effects of the voltage differentials the current distribution improves however some non-uniformity remains. Some brushes still not participating in current sharing. Some improvement seen compared to case 2.

Specific embodiments are shown by way of example in the drawings and will be described herein in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). The words “include,” “including,” and “includes” indicate open-ended relationships and therefore, mean including, but not limited to. Similarly, the words “have,” “having,” and “has” also indicated open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third fastener coupled to a garment” does not preclude scenarios in which a “fourth fastener coupled to the garment” is connected prior to the third fastener, unless otherwise specified. Similarly, a “second” feature does not require that a “first” feature be implemented prior to the “second” feature, unless otherwise specified.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task. In some contexts, “configured to” may be a broad recitation of structure generally meaning performs the task or tasks during operation. As such, the component can be configured to perform the task even when the component is not currently on.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112 paragraph (f), interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF EMBODIMENTS

### Definitions

Unless defined otherwise, all technical and scientific terms used herein have the same meaning as commonly understood by one of ordinary skill in the art.

The term “connected” as used herein generally refers to pieces which may be joined or linked together.

The term “coupled” as used herein generally refers to pieces which may be used operatively with each other, or joined or linked together, with or without one or more intervening members.

The term “directly” as used herein generally refers to one structure in physical contact with another structure, or, when used in reference to a procedure, means that one process effects another process or structure without the involvement of an intermediate step or component.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The following description generally relates to systems and methods for facilitating the welding of large steel beams or girders using a homopolar generator. Homopolar generators themselves were invented by Michael Faraday in 1831. What is disclosed herein, in some embodiments, is the implementation of unique subsystems used in the homopolar generator to allow their operation for the pulsed welding application at a cost that is reasonable for commercialization.

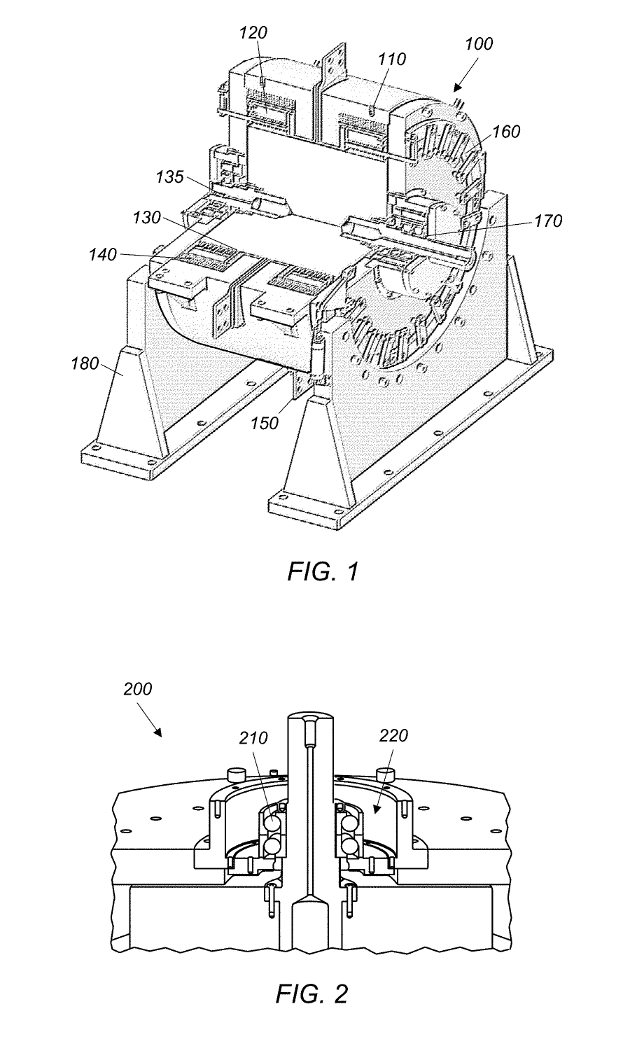

FIG. 1 depicts an embodiment of a cross sectional view of a homopolar generator 100 positioned on a stand 180. In some embodiments, a stator 110 is stationary and carries the magnetic flux from a field coil 120. A rotor 130 spins (e.g., with the assistance of radial bearing 135 and a thrust and radial bearing 170) and stores energy. Brushes 140 on brush actuation ring 160 may be lowered on the rotor surface and carry current out of the machine via the compensation turn. A low impedance output bus bar 150 may take current out and returns it to the machine symmetrically. The output bus bar may deliver current to the weld fixture.

Historically homopolar generators have been built with hydrostatic bearings. These bearings require high power auxiliaries and high pressure oil. Hydrostatic bearings are externally pressurized fluid bearings, where the fluid is usually oil, water or air, and the pressurization is done by a pump. Hydrodynamic bearings rely on the high speed of the journal (the part of the shaft resting on the fluid) to pressurize the fluid in a wedge between the faces. The reason for the use of hydrostatic bearings is that the leakage magnetic field from the generator would lock up steel rolling element bearings and prevent their use. Hydrostatic bearings have their own problems associated with their use in that there is increased cost and maintenance relative to bearings. Replacing hydrostatic bearings with more a more conventional ball bearing would significantly reduce costs for manufacture and use thereof.

In some embodiments, hydrostatic bearings may be replaced by substantially nonmagnetic material based ball bearings. In some embodiments, a homopolar generator may include ceramic rolling element bearings. FIG. 2 depicts an embodiment of a cross sectional view of a bearing assembly 200 of a homopolar generator. The ceramic bearings 210 may be installed on the generator using a preload nut 220 as depicted in FIG. 2. Ceramic bearings are typically formed using ceramic silicon nitride (Si₃N₄) (both lighter and harder than traditional steel bearings). Zirconia is sometimes used to form ceramic bearings. Steel bearings may have a hardness of around 30 million lbs per square inch. Ceramic bearings by comparison may have a hardness of around 47 million lbs per square inch. Thanks to silicon nitride being less dense than steel the bearings may be up to a third lighter than comparable components made from steel. In addition, due to the extra fine finish they are less prone to friction and therefore, create less heat resulting in longer life. Relative to traditional steel bearings, ceramic bearings typically require less lubrication.

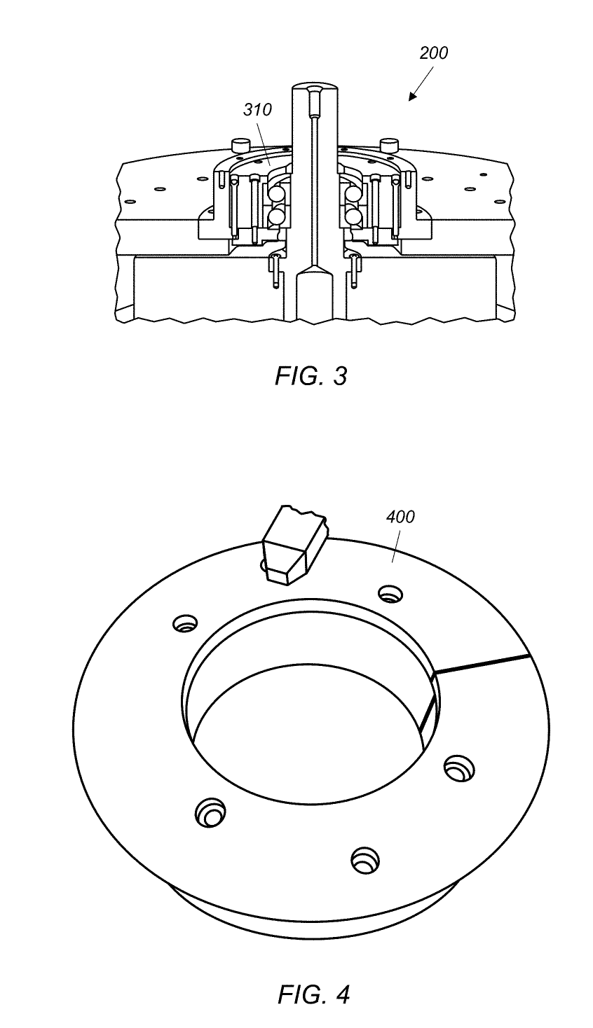

In some embodiments, nonmagnetic bearings may be positioned or housed in a unique bearing housing scheme. The bearing housing may include a radially stiff and circumferentially compliant member for installation and operation of the ceramic bearing. FIG. 3 depicts an embodiment of a cross sectional view of a bearing assembly 300 and a bearing spacer 310 of a homopolar generator. FIG. 4 depicts an embodiment of a perspective view of a bearing spacer 400 of a homopolar generator. The bearing housing may be radially stiff as a result of the materials the housing is formed from. The bearing housing may be circumferentially compliant as a result of a break (e.g., as depicted in FIG. 4) in the housing allowing for expansion/contraction as needed. The nonmagnetic rolling element bearing (e.g., ceramic) may mitigate the problem introduced with steel rolling element bearings. The bearing housing may allow the use of nonmagnetic bearings such as ceramic bearings. This dramatically reduces the cost of the generator in that high pressure hydraulic auxiliaries are no longer required and sump pump systems no longer have to be integrated into bearing housings.

In some embodiments, the homopolar generator may include a sliding electric contact assembly. The electric contact assembly of the generator may allow the transmission of the very high discharge current required of many processes a homopolar generator may be used for (e.g., the welding process). Historically brushes in homopolar generators have been actuated with low profile pneumatic cylinders or bladders requiring a high parts count and cumbersome piping and tubing systems. In some embodiments, a contact assembly may include a mechanical actuator. The mechanical actuation scheme may allow for relatively easier servicing and in some embodiments may be built from relatively inexpensive commercially available piece parts. Laboratory experiments have been conducted to test the brush mechanisms at their full pulsed duty rating.

In some embodiments, the mechanical actuator may deliver the large welding currents required from the generator. The mechanical actuator may allow proper actuation and contact pressure from the brush while retaining desirable features such as trailing arm, electromagnetic assist, and high temperature solder bonding to laminated compliant brush straps. Previous mechanisms have used a pneumatic cylinder to actuate each brush along with the cumbersome tubing schemes required to route pressurized fluids to the cylinders. There can be several hundred brushes in a homopolar generator thereby resulting in the large part counts required to realize previous brush mechanisms. The mechanical actuator described herein is simple, elegant, and cost effective relative to using pneumatic cylinders.

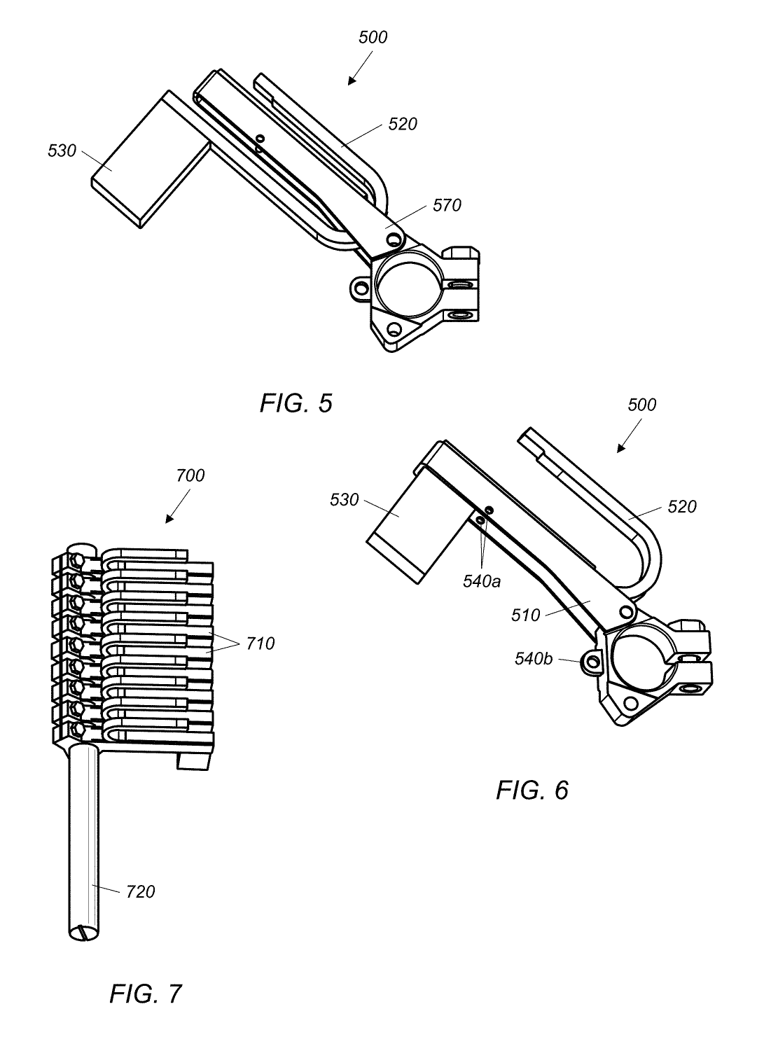

In some embodiments, a brush holder 510 (e.g., commercially available from Caron Brush a subsidiary of Arrowhead Electric Co.) may be used to form a brush device 500. Laminated brush straps 520 (e.g., a plurality of copper straps) may be coupled to a brush pad 530 (e.g., Helwig Carbon Co. brush pad) and inserted into the brush holder (e.g., as depicted in FIG. 5) to form a brush device (e.g., as depicted in FIG. 6). Openings 540a-b may be used to couple opposing ends of a spring for the brush arm. The brush pad may include a copper graphite sintered product attached to a brass base. A brass base may allow the brush pad to be soldered to the laminated straps (e.g., using a high temperature brazing process). The spring may accomplish several different goals. The spring must be carefully chosen based upon the tension of the spring. The spring may hold the brush down against the run out of the rotor and also against any constriction forces that might exist from high current which might blow the brush off the surface of the rotor. While one must be careful not to have a spring which exerts to high of a pressure or this will lead to premature wear of the brush. The number of straps is important, too few straps and the brush may be to stiff and ultimately 12 straps were used.

In some embodiments, magnetic actuation of the brush is important because as the current rises in the brush more interface pressure is required to maintain sliding electric contact and the magnetic pressure supplies this extra force. Essentially the current flowing through the strap is doubled back on itself and a magnetic pressure develops in the gap due to that repulsion of the two opposite currents. This helps as you draw more and more current out of the homopolar generators you would like more downforce to ensure the brush remains in contact with the rotor surface referred to herein as magnetic actuation.

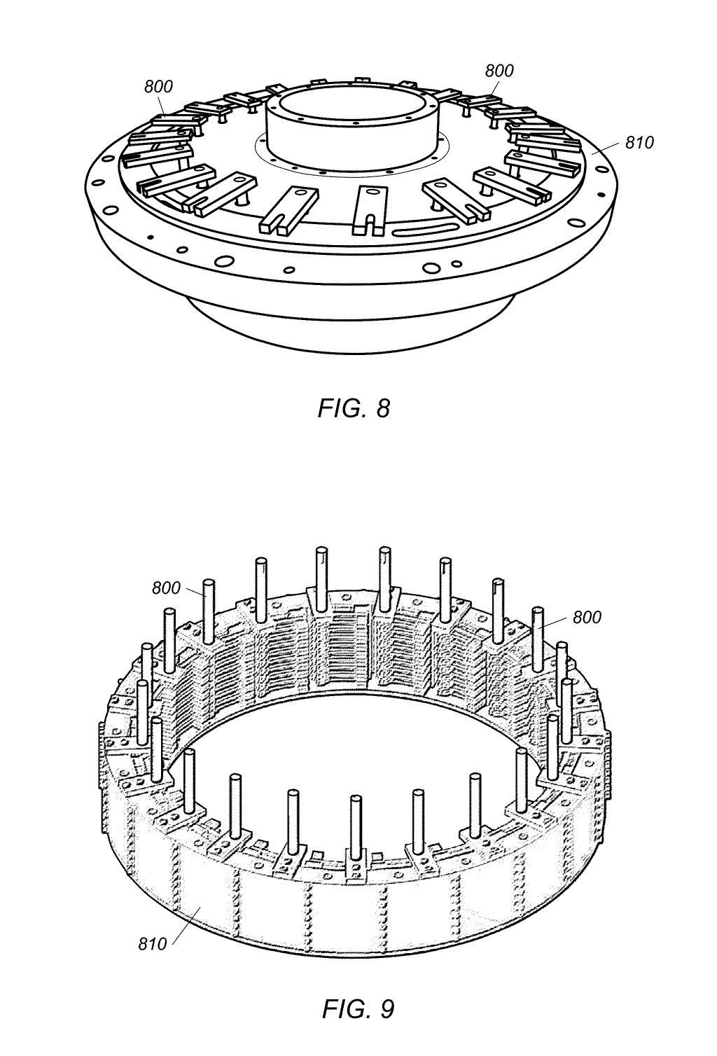

FIG. 7 depicts an embodiment of a perspective view of a brush assembly 700 of a homopolar generator. A plurality of brush devices 710 may be coupled to an actuation rod 720 using an opening in the brush holder (e.g., and a screw or bolt to decrease the opening size to inhibit movement of the brush device relative to the actuation rod during use). The individual brush assemblies 800 (brush devices coupled to the actuation rods) may be mounted to a brush collector ring 810 (e.g., as depicted in FIGS. 8-9). The brush collector ring is the subassembly that is mounted in the homopolar stator.

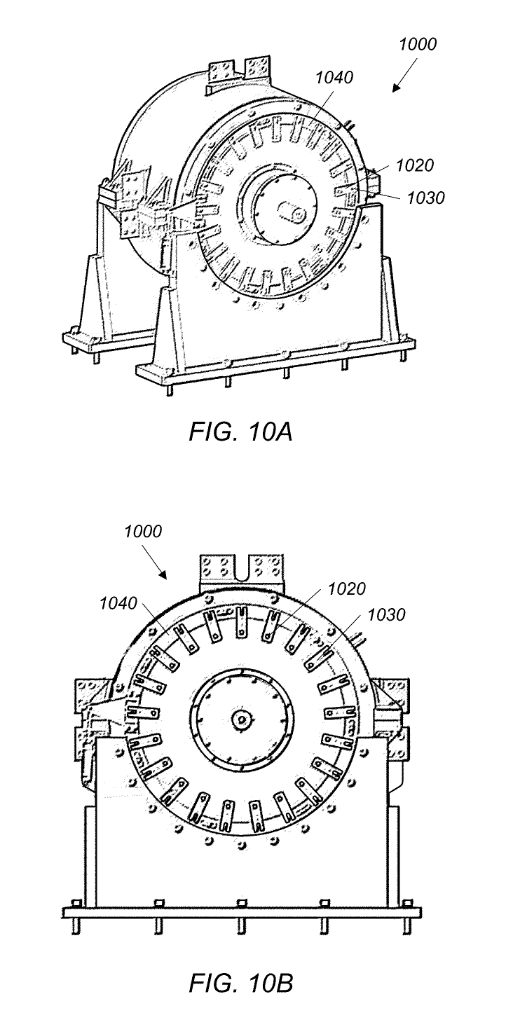

In some embodiments, the homopolar generator 1000 may include a brush actuation mechanism 1010. In some embodiments, the actuator rods 1020 are coupled or directly attached to an external lever 1030 and actuation ring 1040 that allows all of the brushes to contact the homopolar generator rotor at the same time. In some embodiments, the actuator rods may be formed from electrically insulating materials (e.g., a glass epoxy composite). By simply rotating the actuation ring all of the actuation rods (coupled to the actuation ring, for example, using brush actuation arms as depicted in FIGS. 10A-B) may be rotated such that the brush devices contact the homopolar generator rotor at the same time. The ring may be actuated using a number of mechanisms. The ring may be actuated using a pneumatic force; however, as opposed to previous art only one pneumatic actuator is required as opposed to one for every brush (which could easily number in the hundreds). The ring may be coupled to the generator using, for example, shoulder bolts positioned in slotted openings allowing the ring to rotate within a predefined range determined by the size of the opening. In this manner the brushes provide the high current switch required to electrically connect the homopolar generator to an external load. The brushes must be actuated at sufficient speed to act as a switching mechanism to carry the current from the generator.

It should be understood that there may exist a current distribution in the brushes of the generator. This is largely due to the higher resistance introduced by the distance of the brush from the active length and the flux distribution across the brushes introduced by the leakage flux of the field coil. So the strap closest to the rotor is going to try to carry more load than the strap furthest away from the rotor so a distribution of flux leading to not only a resistance gradient but also a voltage gradient leading to a skewed distribution. This may lead to uneven wear of the straps increasing maintenance costs. To address the problem, in some embodiments, the laminated brush straps may be graded in resistance with the more resistive brushes installed closure to the active length of the machine. So an inner strap may have less resistance while an outer strap may have less resistance (e.g., be formed from substantially pure copper).

In some embodiments, the laminated brush straps in the machine may be manufactured from different resistivity material to correct a current distribution issue that occurs due to distributed resistance, inductance and voltage generation. The current distribution may lead to non-uniform wear of the brush material and abbreviated life of the brushes.

The brushes in the homopolar generator are an important component that carries the total current output of the machine which may run into several millions of amps. Besides carrying current, there are other aspects of the brushes that need to be considered. The material chosen for the brushes may have low wear so that they have a long operational life. Brush material may be designed for low friction so as not to put undue drag on the rotor. Brush material may be soft so that it does not wear down the rotor over time. In some embodiments, several of the tribological and conduction requirements are met by using the brush material made of copper graphite. Copper graphite is widely available.

One must ensure that the current distributes well between the brush sets. Typically each brush is capable of carrying a few thousand amps for a few seconds. To build up the current capability as in a homopolar generator, several of these brushes need to operate in parallel. Typically the brushes are arranged in rows of 6 to 10 brushes and several of these rows are distributed circumferentially around the machine. Modeling was performed to determine the current distribution and methods of ensuring an acceptable distribution of currents. Since the resistance of the different brush paths plays a significant role it is important to address this issue. In some embodiments, one way to accomplish this is to include grading resistors in each of the paths. These will force the current to distribute more evenly. Care must be taken not to introduce too much resistance so that the overall process remains efficient.

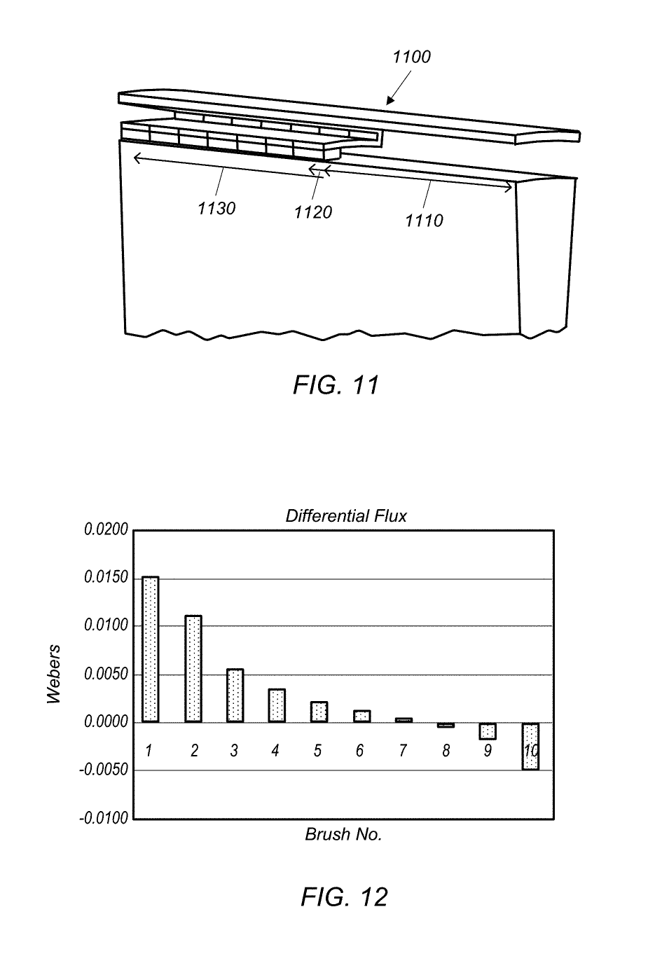

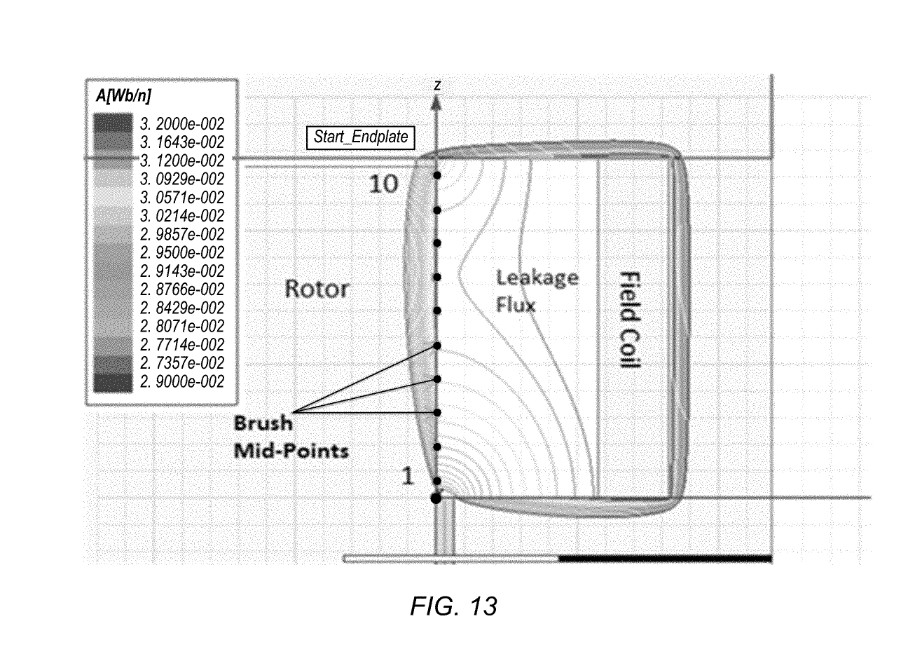

Typically, there are three main causes for the non-uniform distribution of current in the brushes. The first cause may include different resistances across the brush set. FIG. 11 shows a typical brush arrangement 1100 for one row. Varying resistance for the brush paths wherein typically the brush closest to the active length 1110 has the lowest resistance 1120 and the one furthest has the highest 1130. The second cause may include different inductances across the brush sets. This follows the same pattern as the resistances i.e. the brush closest to the active length has the lowest inductance. Also, it is to be born in mind that the inductances are coupled. For a homopolar type pulse which is typically fairly long (a few seconds) the inductances do not play as strong a roll in the current distribution. The third cause may include the non-uniform flux linkages for the different brush paths due to leakage fields in the brush region, as shown in FIG. 12 and FIG. 13. As one moves from the brush no. 1 to no. 10 the flux linkages increase resulting in a higher voltage for the brushes further away from the active length. This of course has an offsetting effect on the uneven distribution due to effects (1) and (2) above.

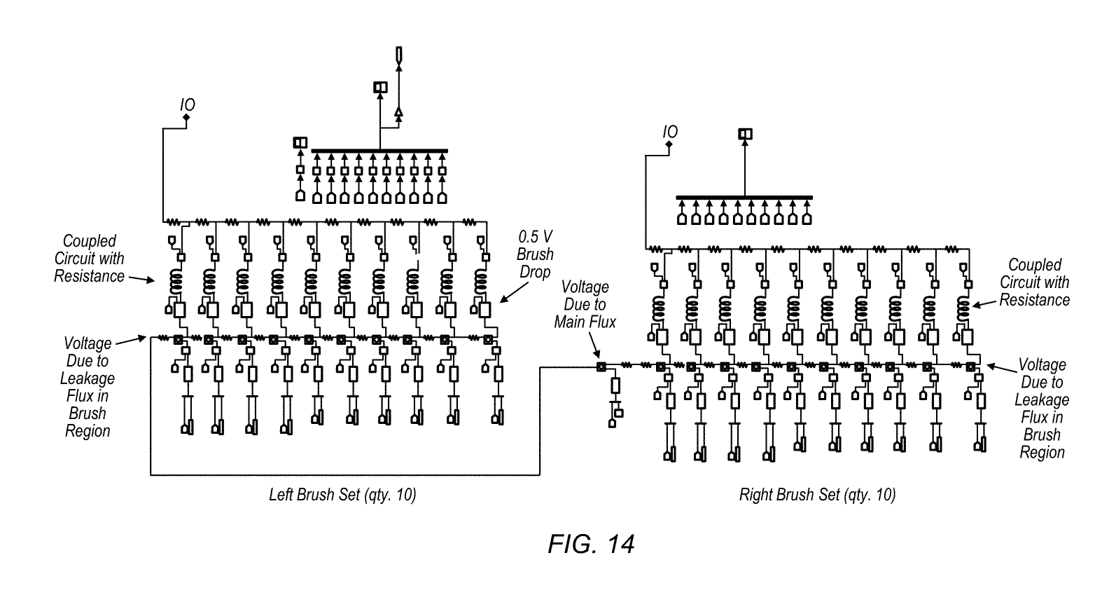

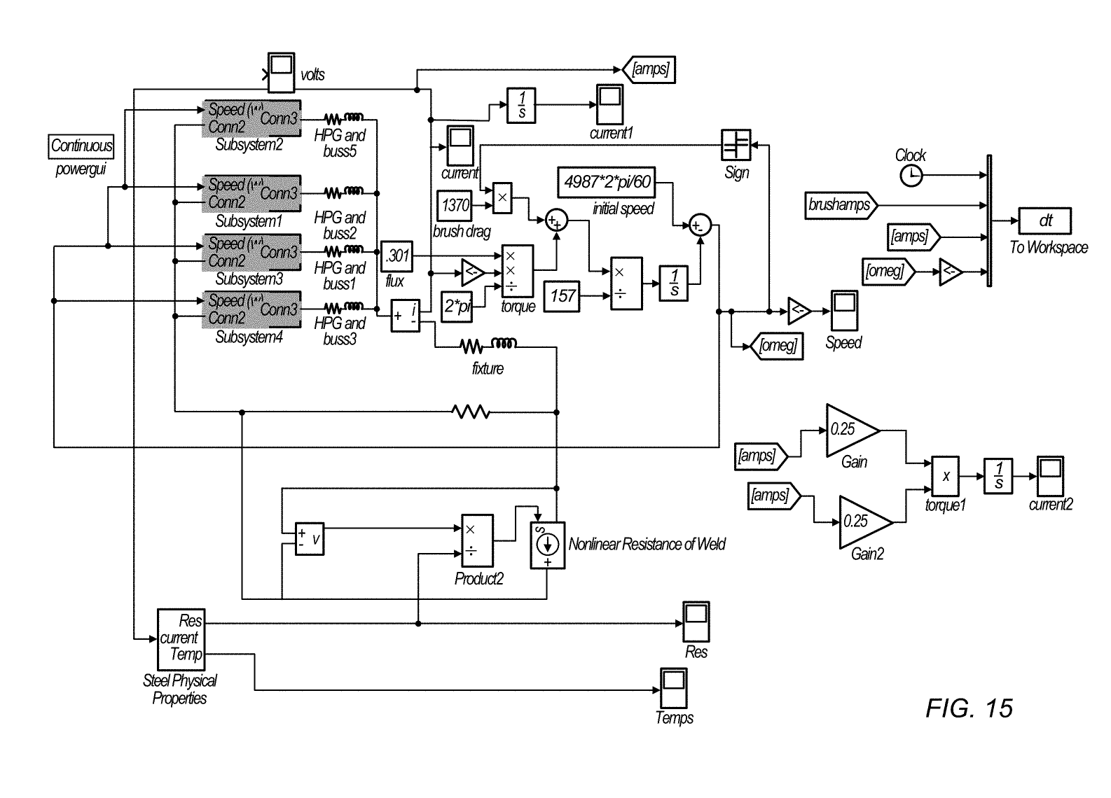

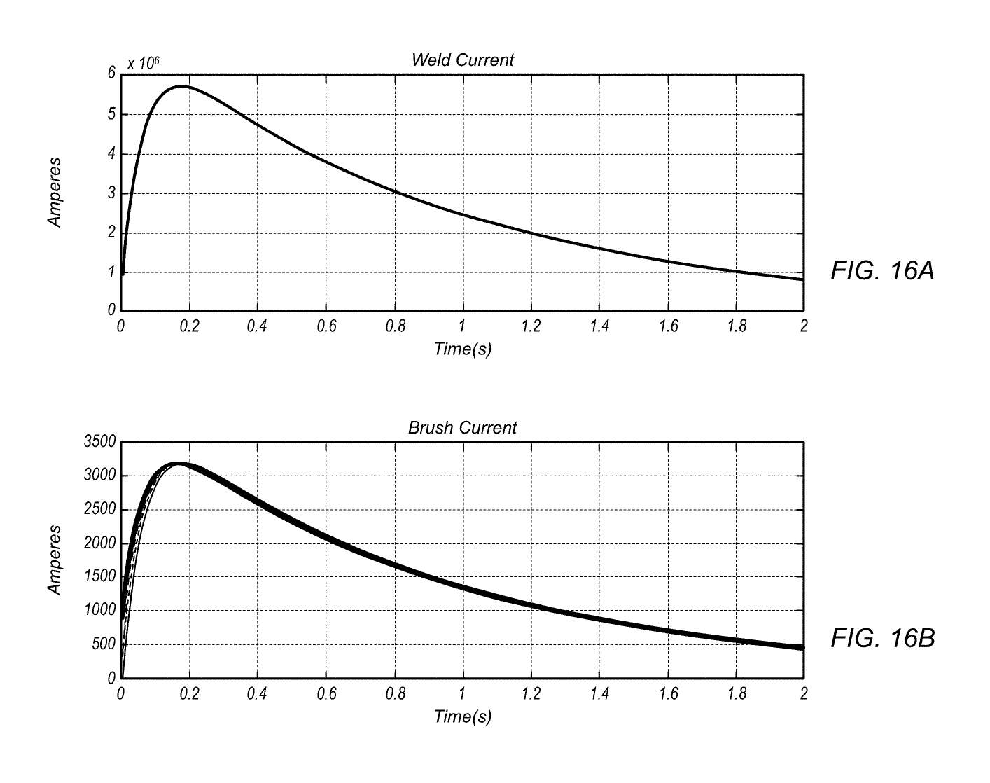

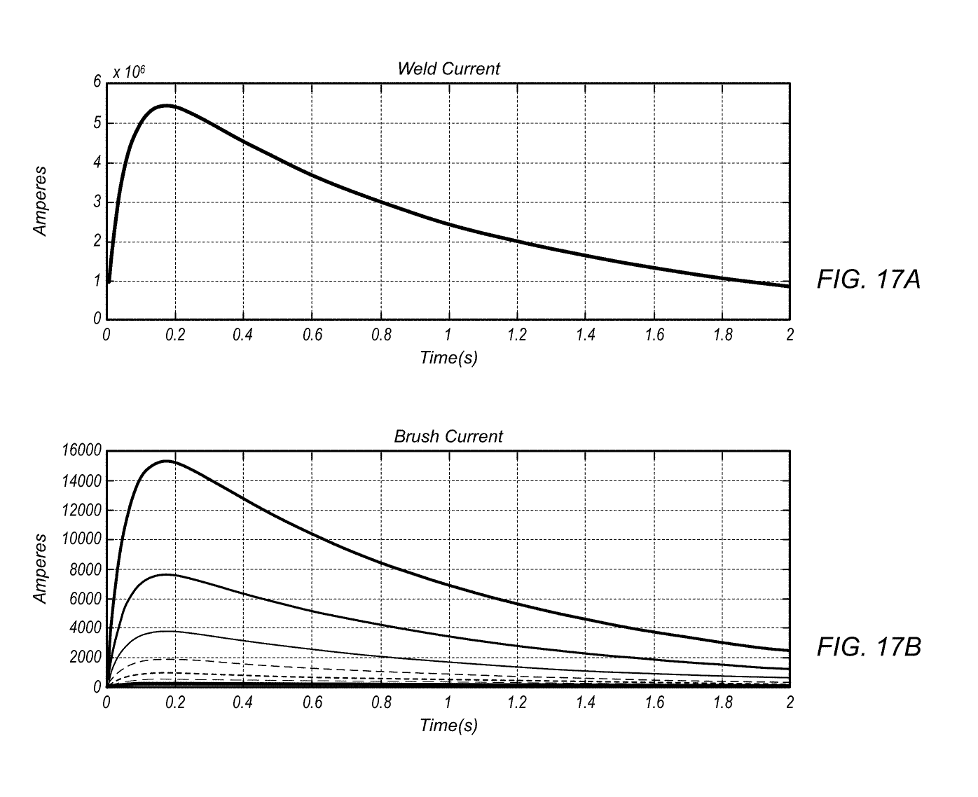

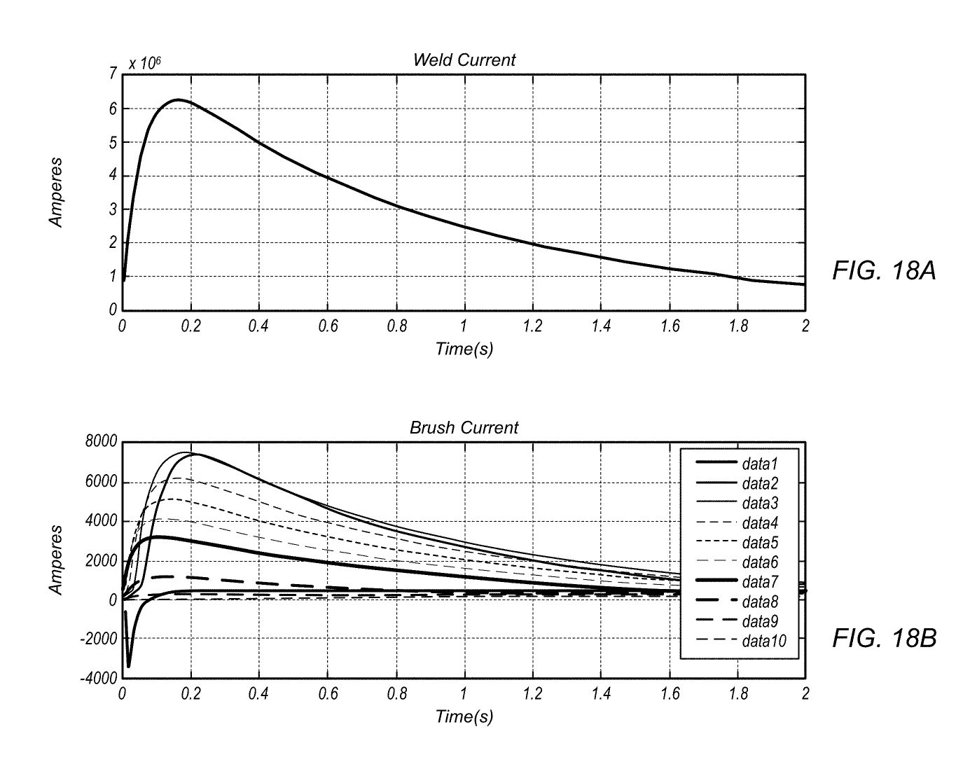

A model that determines the current distribution in the brushes must address the discussed effects and in addition must include other effects such as the 0.5 V (this is a typical value used for modeling) brush drop across the brush rotor interface. The Matlab/Simulink model shows the detailed model that accounts for the three effects mentioned above, FIG. 14. FIG. 14 depicts a detailed model in Matlab/Simulink to determine brush current distribution. The coupled circuit model accounts for the inductance and resistances. The shaded voltage sources represent the differential voltages. The model depicts the voltage generated in the active length, and the voltage drop at the brush rotor interface. The voltage generated in the main flux and due to the differential flux is a function of the rotor speed. With this detailed representation of each homopolar generator a simulation was put together that represented a four homopolar generator machine system feeding through a common bus into a weld. This model is depicted in FIG. 15. FIG. 15 depicts a System Simulation with the 4 HPGs (shaded blocks) that are based on the detailed model of FIG. 14 to study the current distribution under the actual pulse shape. Three different cases were studied:
Case 1: Ideal situation with no resistance differences or flux gradients due to leakage fields (FIGS. 16A-B depict results of the simulation of the current distribution for case 1. Since this is the ideal cases the currents distribute fairly uniformly. The slight uneven distribution initially is due to the inductances being different for each path, in general the current distribution is fairly uniform.).
   Eliminate Differential Flux
   Reduce the iron and comp. turn resistance to negligible
Case 2: Introduce one effect at a time to see the sensitivity (FIGS. 17A-B depict results of the simulation of the current distribution for case 2. The current distribution is very non-uniform with some of the brushes not carrying any current and some carrying significantly higher than rated.).
   Eliminate only Differential Flux
Case 3: All effects accounted for (FIGS. 18A-B depict results of the simulation of the current distribution for case 3. Due to the offsetting effects of the voltage differentials the current distribution improves however some non-uniformity remains. Some brushes still not participating in current sharing. Some improvement seen in case 3 relative to case 2).
   Retain all aspects of the model

Since the resistance of the different brush paths plays a significant role it is important to address this issue. In some embodiments, grading resistors may be included in each of the paths to compensate for the resistance of different brush paths. These will force the current to distribute more evenly. Care must be taken not to introduce too much resistance so that the overall process remains efficient. It can be seen from TABLE 1 that there are a wide range of laminated brush strap materials that may provide the resistance grading.

TABLE 1
Candidate materials for laminated brush straps

| material | Resistivity (microhm-cm) |
|---|---|
| CDA 110 copper | 1.71 |
| C18000 chrome copper | 2.15 |
| Dispersion strengthened copper | 2.21 |
| Brass | 3.9 |
| Beryllium copper | 8.26 |
| Aluminum Bronze | 9.9 |

In some embodiments, an integrated low inertia induction motor may be used to motor the machine. The motor stays connected to the rotor shaft during discharge.

In some embodiments, internal components of the machine that see electric potential are coated with high strength urethane to prevent casual short circuits.

There are many different uses which a more cost effective and efficient homopolar generator may be used for including welding, sintering, and billet heating. One use in particular is welding. Homopolar generators are different from a battery in that the generator has two control parameters that establish the voltage, rotor speed and magnetic flux. The capacitance and therefore, the output pulse shape is changed by controlling the magnetic field. This is done very simply by changing the current in the field coil of the machine. This ability to control the rate at which energy enters the weld inhibits weld blow out of thin cross sections, by for example slowing the pulse down provides full diffusion into large cross sections, and providing a long slow input of energy following a weld provides post weld heat treatment.

Previous attempts to introduce homopolar generator welding into the commercial market have faltered due to the capital expense of the machine and the long pay back. With the new subsystems disclosed herein for the generator the capital cost has been reduce significantly and the pay back interval is acceptable. There are distinct advantages that homopolar generator welding of high performance steel has including saving time and capital over the existing process of Submerged Arc Welding (SAW). The homopolar generator pulsed welding which may require hours of setup and seconds of weld time greatly outperforms the previous technology which requires hours of setup and a day and a half of welding.

With pipe welding the grips used to apply upset force to the weld area during pulsed resistance would introduce stress concentrations in the surface of the pipe. Because bridge girders are finite length the upset force can be applied from the ends of the workpiece and no grips are required and stress concentrations are not introduced to the surface of the girder. With any new welding process the welds have to be certified by the regulatory institute guiding the technology. Because high performance steel pipe has already been welded and coupon results reviewed by recognized companies in the pipe welding field it is expected that the inspection of the high performance steel used in bridge girders will also pass inspection.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A homopolar generator system, comprising:
a radial bearing rotor comprising a rotatable shaft and a bearing assembly positioned on the rotatable shaft, wherein the bearing assembly comprises nonmagnetic bearings;
a field coil, wherein the radial bearing rotates, during use, in the field coil with assistance of the bearing assembly;
a plurality of brush devices which when activated engage the rotating radial bearing rotor during use; and
a brush actuation mechanism which when activated engages, during use, the plurality of brush devices to the radial bearing rotor.

2. The system of claim 1, wherein the nonmagnetic bearings comprise ceramic bearings.

3. The system of claim 1, wherein at least one of the plurality of brush devices comprises at least one grading resistor.

4. The system of claim 1, wherein at least one of the plurality of brush devices comprises a brush formed at least in part from a material with less than 10.0 microhm-cm resistivity.

5. The system of claim 1, wherein at least one of the plurality of brush devices comprises a brush formed at least in part from copper graphite.

6. The system of claim 1, wherein at least one of the plurality of brush devices comprises a brush formed at least in part from CDA 110 copper, C18000 chrome copper, dispersion strengthened copper, brass, beryllium copper, and/or aluminum bronze.

7. The system of claim 1, further comprising a bearing housing positioned on the rotatable shaft such that the bearing assembly is inhibited from disengaging from the rotatable shaft.

8. The system of claim 7, wherein the bearing housing is radially stiff and circumferentially compliant.

9. The system of claim 7, wherein the bearing housing is formed from a substantially inflexible material and include a small break in an otherwise uninterrupted circular shape allowing contraction and/or expansion of the circular shape.

10. The system of claim 1, wherein the plurality of brush devices comprise a brush holder comprising a brush pad, a plurality of straps, and a resilient member.

11. The system of claim 1, wherein the plurality of brush devices are coupled to at least one actuator rod.

12. The system of claim 1, wherein the plurality of brush devices are coupled to at least one actuator rod, wherein the at least one actuator rod is formed from an electrically insulated material.

13. The system of claim 12, wherein the brush actuation mechanism comprises an actuation ring coupled to the at least one actuator rod such that when the actuation ring is rotated the plurality of brush devices engage the radial bearing rotor.

14. A method of welding girders, comprising:
activating a homopolar generator;
applying a force to two metal girders at a desired coupling joint;
generating an electrical pulse using the homopolar generator and conducting the electrical pulse to the desired coupling joint to increase a temperature of the girders adjacent the desired coupling joint; and
forming a weld at the desired coupling joint attaching the two metal girders at the desired coupling joint.

15. The method of claim 14, wherein the homopolar generator comprises:
a radial bearing rotor comprising a rotatable shaft and a bearing assembly positioned on the rotatable shaft, wherein the bearing assembly comprises nonmagnetic bearings;
a field coil, wherein the radial bearing rotates, during use, in the field coil with assistance of the bearing assembly;
a plurality of brush devices which when activated engage the rotating radial bearing rotor during use; and
a brush actuation mechanism which when activated engages, during use, the plurality of brush devices to the radial bearing rotor.

16. The method of claim 15, wherein at least one of the plurality of brush devices comprises at least one grading resistor.

17. The method of claim 15, wherein at least one of the plurality of brush devices comprises a brush formed at least in part from a material with less than 10.0 microhm-cm resistivity.

18. The method of claim 15, wherein at least one of the plurality of brush devices comprises a brush formed at least in part from copper graphite.

19. The method of claim 15, further comprising uniformly distributing a current among brushes of the plurality of brush devices.

20. The method of claim 15, wherein at least one of the plurality of brush devices comprises a brush formed at least in part from CDA 110 copper, C18000 chrome copper, dispersion strengthened copper, brass, beryllium copper, and/or aluminum bronze.
